(19) United States
(12) Patent Application Publication
(10) Pub. No.: US 2008/0178439 A1
(43) Pub. Date: Jul. 31, 2008

(54) STRAP-TIGHTENING APPARATUS

(76) Inventor: Han-Ching Huang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/668,711

(22) Filed: Jan. 30, 2007

(51) Int. Cl. B25B 25/00

(52) U.S. Cl. 24/68 CD

(57) ABSTRACT

A strap-tightening apparatus includes a base, a handle pivotally disposed on the base and a hollow reel rotationally disposed on the base for reeling a strap. A first spring-loaded detent is disposed on the base. A second spring-loaded detent is disposed on the handle. The ratchet wheels are attached to the hollow reel. The ratchet wheels engage with the second spring-loaded detent during the rotation of the handle in a direction so that the handle causes the hollow reel to reel in the strap. The ratchet wheels engage with the first spring-loaded detent in the rotation of the handle in an opposite direction so that the handle does not cause the hollow reel to reel out the strap. The recovering element is formed with a first end connected to the hollow reel and a second end connected to the base for causing the reel to reel out the strap.

### BACKGROUND OF INVENTION

1. Field of Invention

The present invention relates to a strap-tightening apparatus.

2. Related Prior Art

As disclosed in Taiwanese Patent 1257906 issued to the applicant of the present application, a strap-tightening apparatus includes a base 10, a first spring-loaded detent 14, a handle 20, a second spring-loaded detent 22, a reel 12, two ratchet wheels 13 and a recovering device 30. The recovering device 30 returns the reel 12 to its original position after the spring-loaded detents 14 and 22 are both disengaged from the ratchet wheels 13. This conventional strap-tightening apparatus is however big since the recovering device 30 is disposed on an external side of the base 10. Moreover, this conventional strap-tightening apparatus is complicated since the recovering device 30 includes several parts.

Another conventional strap-tightening apparatus can be found in U.S. Pat. No. 6,609,275. This conventional strap-tightening apparatus includes a reeling unit and a tightening unit. A first strap 20 is connected to the tightening unit. The tightening unit includes a reel 80. A second strap 30 is inserted through the reel 80 so that the second strap 30 is tighten when the reel 80 is rotated. The reeling unit includes a reel 121 for reeling the second strap 30 and a coil spring 122 for returning the reel 121 to its original position. However, like any tape measure, the size of the coil spring 122 limits the length of the strap 30. If a long strap 30 is needed, a large coil spring 122 is required. If the coil spring 122 is small, the strap 30 would be too short for use. Furthermore, this conventional strap-tightening apparatus is complicated in structure for including two reels 80 and 121 and many other elements. Moreover, the coil spring 122 causes the reel 121 to reel in the second strap 30 that might cause some trouble for a user while trying to remove a hook 31, which is connected to the second strap 30, from an object.

The present invention is therefore intended to obviate or at least alleviate the problems encountered in prior art.

### SUMMARY OF INVENTION

According to the present invention, a strap-tightening apparatus includes a base, a handle pivotally disposed on the base and a hollow reel rotationally disposed on the base for reeling a strap. A first spring-loaded detent is disposed on the base. A second spring-loaded detent is disposed on the handle. The ratchet wheels are attached to the hollow reel. The ratchet wheels engage with the second spring-loaded detent during the rotation of the handle in a direction so that the handle causes the hollow reel to reel in the strap. The ratchet wheels engage with the first spring-loaded detent in the rotation of the handle in an opposite direction so that the handle does not cause the hollow reel to reel out the strap. The recovering element is formed with a first end connected to the hollow reel and a second end connected to the base for causing the reel to reel out the strap.

An advantage of the fastener according to the present invention is a small size since the recovering element is disposed in the hollow reel.

Another advantage of the fastener according to the present invention is durability since the recovering element is protectively disposed in the hollow reel.

Still another advantage of the fastener according to the present invention is a small number of elements.

Other advantages and features of the present invention will become apparent from the following description referring to the drawings.

### BRIEF DESCRIPTION OF DRAWINGS

The present invention will be described through detailed illustration of two embodiments referring to the drawings wherein:

FIG. 1 is a perspective view of a strap-tightening apparatus according to the first embodiment of the present invention.

FIG. 2 is an exploded view of the strap-tightening apparatus shown in FIG. 1.

FIG. 3 is a cross-sectional view of the strap-tightening apparatus shown in FIG. 1.

FIG. 4 is another cross-sectional view of the strap-tightening apparatus shown in FIG. 3.

FIG. 5 is an enlarged partial view of the strap-tightening apparatus shown in FIG. 4.

FIG. 6 is a cross-sectional view of the strap-tightening apparatus in another position than shown in FIG. 4.

FIG. 7 is an enlarged partial view of the strap-tightening apparatus shown in FIG. 6.

FIG. 8 is a perspective view of a handle used in a strap-tightening apparatus according to the second embodiment of the present invention.

FIG. 9 is an exploded partial view of the strap-tightening apparatus shown in FIG. 8.

FIG. 10 is a cross-sectional view of the strap-tightening apparatus shown in FIG. 8.

FIG. 11 is another cross-sectional view of the strap-tightening apparatus shown in FIG. 8.

FIG. 12 is a cross-sectional view of the strap-tightening apparatus in another position than shown in FIG. 11.

### DETAILED DESCRIPTION OF EMBODIMENTS

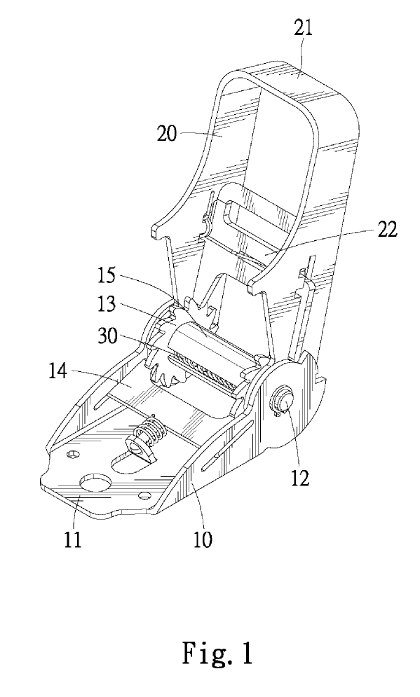

Referring to FIG. 1, there is shown a strap-tightening apparatus according to a first embodiment of the present invention. The strap-tightening apparatus includes a base 10, a handle 20, a reel 15 and a recovering element 30.

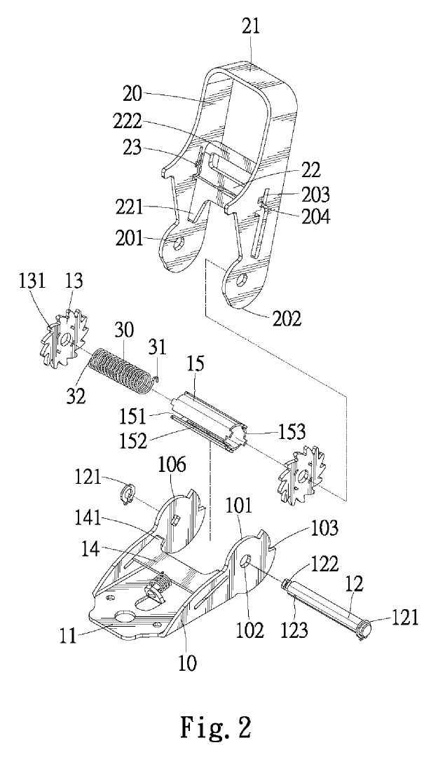

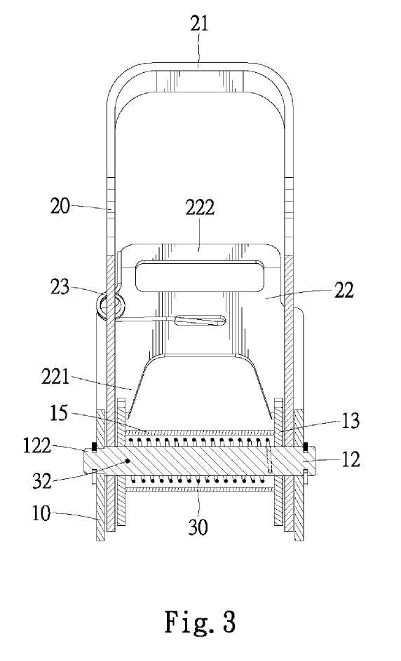

Referring to FIGS. 2 and 3, the frame 10 includes a floor 11 and two walls on the floor 11. The floor 11 defines an aperture for receiving a stem, a hook or a loop. Each of the walls defines a slot.

One of the walls includes an aperture 102 therein, a first arched edge 101, a second arched edge further from the aperture 102 than the first edge 101, a third arched edge further from the aperture 102 than the second arched edge and a cutout 103 between the second and third arched edges. The aperture 102 is circular.

The other wall includes an aperture 106 therein, a first arched edge 101, a second arched edge further from the aperture 102 than the first edge 101, a third arched edge further from the aperture 102 than the second arched edge and a cutout 103 between the second and third arched edges. The aperture 106 is square.

A first detent 14 includes two wings 141 movable in the slots of the base 10. An elastic element is arranged between the first detent 14 and the base 10.

The handle 20 includes two lateral portions and a grip 21 between the lateral portions. Each of the lateral portions includes a cam 202 thereon, an aperture 201 in the cam 202, a slot 203 therein and a tab 204 thereon within the slot 203.

A second detent 22 includes two wings 221 movable in the slots 203, a grip 222 opposite to the wings 221 and a slot between the grip 222 and the wings 221. An elastic element 23 includes two helical terminal portions disposed around the tabs 204 and a central portion disposed in the slot of the second detent 22.

The reel 15 is a tubular element defining, in the periphery, two slots 151 and 152 and an aperture 153.

There are provided two ratchet wheels 13 each including ratchets 131 thereon.

A pin 12 includes a square portion 122 at an end, an aperture 123 therein near the square portion 122 and two annular grooves in the periphery near both ends.

The recovering element 30 is preferably a helical spring including a hooked end 31 and a rectilinear end 32.

The recovering element 30 is disposed in the reel 15. The first end 31 of the recovering element 30 is disposed in the aperture of the reel 15. The ratchet wheels 13 are attached to the reel 15 so that they can be rotated together. The pin 12 is inserted through the aperture 102, the ratchet wheels 13, the recovering element 30 and the reel 15. The square portion 122 of the pin 12 is disposed in the aperture 106 so that the pin 12 is not rotational on the frame 10. The second end 32 of the recovering element 30 is inserted in the aperture 123 of the pin 12. A C-clip 121 is fit in each of the annular grooves of the pin 12.

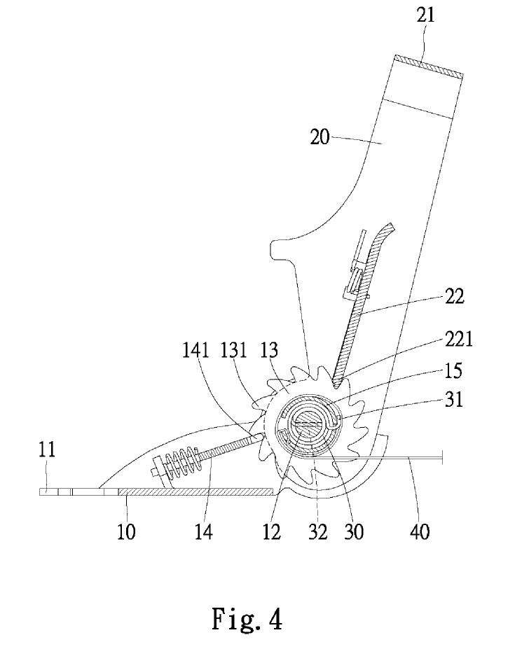

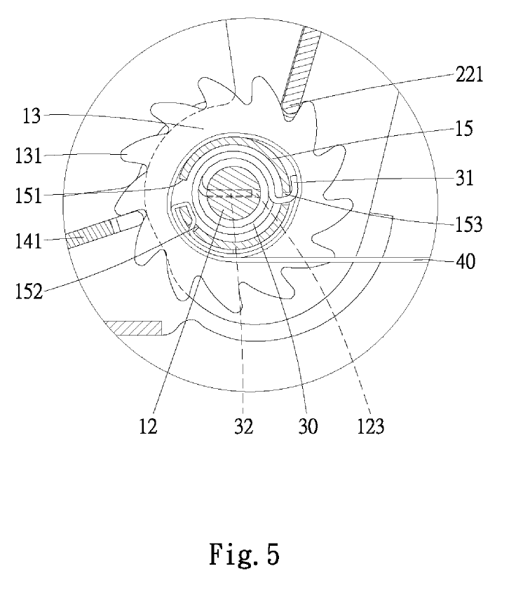

Referring to FIGS. 4 and 5, a strap 40 is inserted through the slots 151 and 152 and preliminarily tightened. When the handle 20 is pivoted on the base 10 in a direction, the wings 221 engage with the ratchets 131 while the wings 141 rattle on the ratchets 131 so that the reel 15 is rotated. Therefore, the strap 40 is reeled in and further tightened while the recovering element 30 is loaded. When the handle 20 is pivoted on the base 10 in an opposite direction, the wings 221 rattle on the ratchets 131 while the wings 141 engage with the ratchets 131 so that the reel 15 is kept in position. Therefore, the strap 40 is kept tightened while the recovering element 30 is kept loaded. The handle 20 can be pivoted to and from several times until the strap 40 is properly tightened.

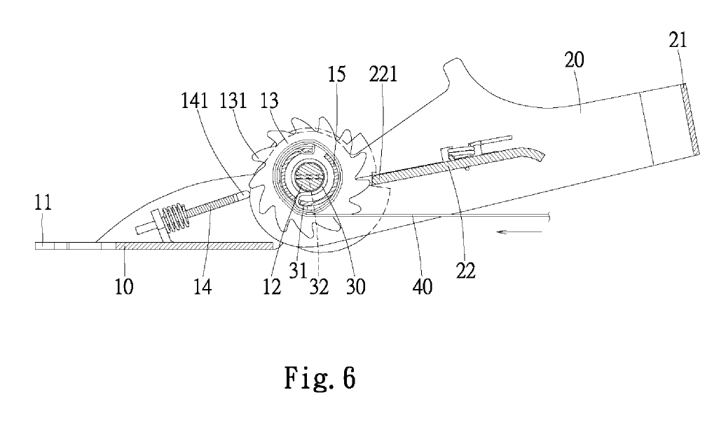

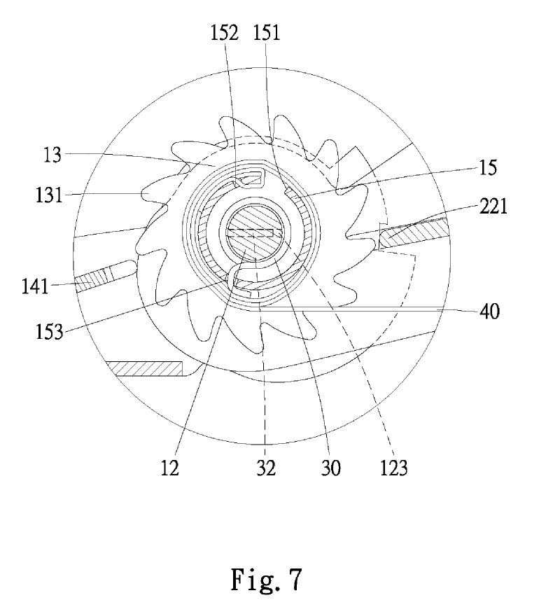

Referring to FIGS. 6 and 7, the handle 20 is pivoted on the base 10 to another position. By maneuvering the grip 222, the wings 221 are disengaged from the ratchets 131 and disposed in the cutouts 103. The cams 202 disengage the wings 141 from the ratchets 131. The reel 15 is quickly returned to its original position by the recovering element 30.

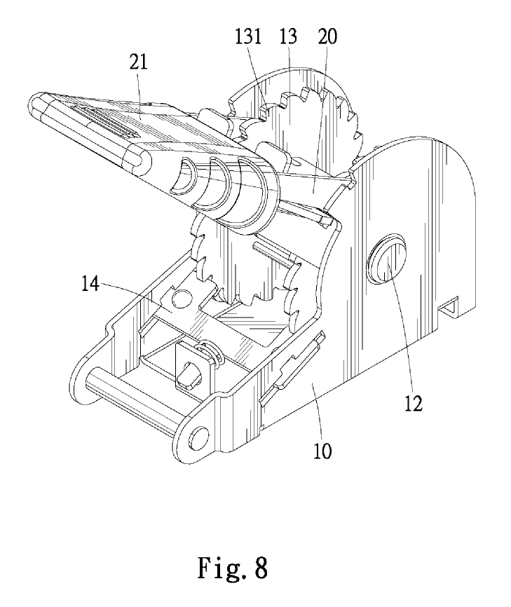

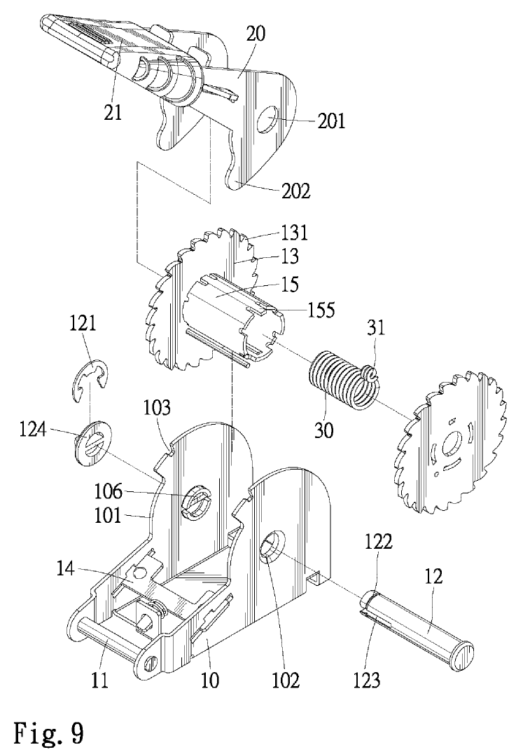

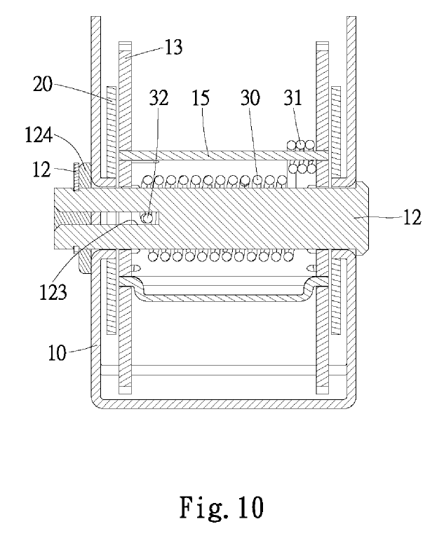

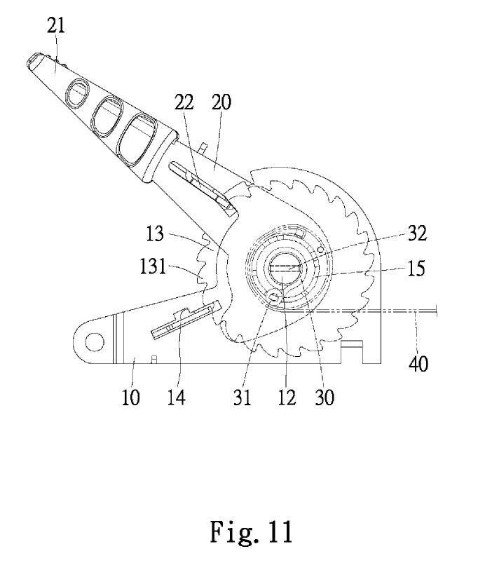

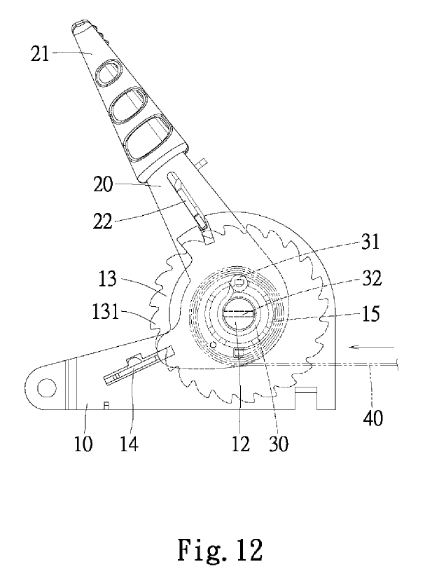

Referring to FIGS. 8 through 12, there is shown a fastener according to a second embodiment of the present invention. The second embodiment is like the first embodiment except a few things. Firstly, the reel 15 includes a tab 155 formed at an end. Secondly, the first end 31 of the recovering element 30 is a helical portion disposed around the tab 155. Thirdly, the pin 12 defines a slit 123. Fourthly, a reinforcing element 124 is used to reinforce the pin 12. The reinforcing element 124 includes an annular portion disposed around the pin 12 and a rectilinear portion fit in the slit 123.

An advantage of the fastener according to the present invention is a small size since the recovering element 30 is disposed in the reel 15.

Another advantage of the fastener according to the present invention is durability since the recovering element 30 is protectively disposed in the reel 15.

Still another advantage of the fastener according to the present invention is a small structure for including the single recovering element.

The present invention has been described via the detailed illustration of the embodiments. Those skilled in the art can derive variations from the embodiments without departing from the scope of the present invention. Therefore, the embodiments shall not limit the scope of the present invention defined in the claims.

What is claimed is:

1. A strap-tightening apparatus comprising:
a base;
a first spring-loaded detent disposed on the base;
a handle pivotally disposed on the base;
a second spring-loaded detent disposed on the handle;
a hollow reel rotationally disposed on the base for reeling a strap;
two ratchet wheels attached to the hollow reel for engagement with the second spring-loaded detent during the rotation of the handle in a direction so that the handle causes the hollow reel to reel in the strap and engagement with the first spring-loaded detent during the rotation of the handle in an opposite direction so that the handle does not cause the hollow reel to reel out the strap; and
a recovering element formed with a first end connected to the hollow reel and a second end connected to the base for causing the reel to reel out the strap.

2. The strap-tightening apparatus according to claim 1 comprising a pin inserted through the recovering element and non-rotationally disposed on the base, and the second end of the recovering element is connected to the pin.

3. The strap-tightening apparatus according to claim 2 wherein the base defines a non-circular aperture, and the pin comprises a non-circular portion fit in the non-circular aperture.

4. The strap-tightening apparatus according to claim 2 comprising two C-clips for clipping and retaining the pin on the base.

5. The strap-tightening apparatus according to claim 2 wherein the pin defines an aperture for receiving the second end of the recovering element.

6. The strap-tightening apparatus according to claim 2 wherein the pin defines a slit for receiving the second end of the recovering element.

7. The strap-tightening apparatus according to claim 6 comprising a reinforcing element for reinforcing the pin.

8. The strap-tightening apparatus according to claim 7 wherein the reinforcing element comprises an annular portion disposed around the pin and an annular portion fit in the slit.

9. The strap-tightening apparatus according to claim 1 wherein the hollow reel comprises a tab at an end, and the first end of the recovering element is a helical portion disposed around the tab.

10. The strap-tightening apparatus according to claim 1 wherein the hollow reel defines, in the periphery, two slots for receiving the strap.

11. The strap-tightening apparatus according to claim 1 wherein the recovering element is a helical spring.
